(19) United States
(12) Patent Application Publication
(10) Pub. No.: US 2026/0035605 A1
(43) Pub. Date: Feb. 5, 2026

(54) SHALE SWELLING INHIBITION IN WELLBORE

(71) Applicant: KING FAHD UNIVERSITY OF PETROLEUM AND MINERALS, Dhahran (SA)

(72) Inventors: Afeez Olayinka GBADAMOSI, Dhahran (SA); Mobeen MURTAZA, Dhahran (SA); Muhammad Shahzad KAMAL, Dhahran (SA); Syed Muhammad Shakil HUSSAIN, Dhahran (SA); Shirish Liladhar PATIL, Dhahran (SA)

(73) Assignee: KING FAHD UNIVERSITY OF PETROLEUM AND MINERALS, Dhahran (SA)

(21) Appl. No.: 19/046,331

(22) Filed: Feb. 5, 2025

Related U.S. Application Data
(60) Provisional application No. 63/679,014, filed on Aug. 2, 2024.

(51) Int. Cl. C09K 8/22

(52) U.S. Cl. CPC C09K 8/22

(57) ABSTRACT

A method of reducing shale swelling in a wellbore having a shale formation includes contacting a wall of the wellbore with a water-based drilling mud to reduce the absorption of water from the water-based drilling mud into the shale formation. The drilling mud is an aqueous solution which includes at least 0.1 w/v % of a carboxybetaine zwitterionic surfactant. The shale swelling is reduced by at least 10% compared to a water-based mud that is the same as the water-based drilling mud but does not contain the carboxybetaine zwitterionic surfactant.

### CROSS REFERENCE TO RELATED APPLICATIONS

This application claims the benefit of priority of U.S. Provisional Application No. 63/679,014 filed Aug. 2, 2024, the entire contents of which are herein incorporated by reference.

### BACKGROUND OF THE INVENTION

### Technical Field

The present disclosure is directed towards shale swelling inhibition methods, and more particularly, towards a method of reducing shale swelling in a wellbore using a zwitterionic surfactant.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

During drilling operations, drilling muds allow for the transportation of cuttings and stabilization of the wellbore pressure during oil and gas exploration and production. Drilling muds are classified as water-based drilling mud (WBM) and oil-based drilling mud (OBM). While OBMs have good efficiency during drilling operations, they are less desired due to their inclusion of heavy metals and other toxic additives that can seem into the soil and groundwater, posing detrimental environmental and health hazards. WBMs pose a less toxic alternative to OBMs, however, WBMs may react with clays, causing shale swelling due to the interaction between the water in the drilling mud and the clay minerals within the shale. WBMs may further corrode drilling equipment and not be effect in high-temperature or high-pressure environments. Therefore, there exists a need for an effective, non-toxic WBM that minimizes shale swelling during drilling operations.

Accordingly, one object of the present disclosure is to provide a method for reducing shale swelling in a wellbore using a water-based drilling mud comprising a carboxybetaine zwitterionic surfactant, that may circumvent the drawbacks and limitations of water-based drilling muds, such as, low drilling efficiency and enhanced shale swelling.

### SUMMARY

In an exemplary embodiment, a method of reducing shale swelling in a wellbore having a shale formation is described. The method comprises contacting a wall of the wellbore with a water-based drilling mud to reduce absorption of water from the water-based drilling mud into the shale formation. The drilling mud is an aqueous solution comprising at least 0.1 w/v % of a carboxybetaine zwitterionic surfactant of Formula I relative to a total volume of the water-based drilling mud,

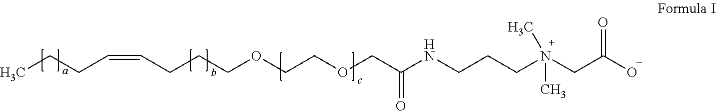

where a, b, and c are individually an integer from 1 to 20. The shale swelling is reduced by at least 10% compared to a water-based mud that is the same as the water-based drilling mud but does not contain the carboxybetaine zwitterionic surfactant.

In some embodiments, the water-based drilling mud has a zeta potential of at least −31 millivolts (mV).

In some embodiments, the shale swelling is reduced by at least 30% compared to a water-based drilling mud that is the same as the water-based drilling mud but does not contain the carboxybetaine zwitterionic surfactant.

In some embodiments, the water-based drilling mud has a stability index of at least 0.40 after 50,000 second (sec).

In some embodiments, the water-based drilling mud further comprises 0.01 to 0.10 w/v % of at least one inorganic base selected from the group including potassium hydroxide (KOH), calcium hydroxide (Ca(OH)₂), magnesium hydroxide (Mg(OH)₂), barium hydroxide (Ba(OH)₂), and sodium hydroxide (NaOH).

In some embodiments, the water-based drilling mud is an aqueous solution comprising at least 0.25 w/v % of the carboxybetaine zwitterionic surfactant relative to a total volume of the water-based drilling mud.

In some embodiments, the shale swelling is reduced by at least 42% compared to a water-based drilling mud that is the same as the water-based drilling mud but does not contain the carboxybetaine zwitterionic surfactant.

In some embodiments, the water-based drilling mud further comprises 0.04 to 0.045 w/v % of sodium hydroxide.

In some embodiments, the water-based drilling mud further comprises 1 to 10 w/v % of at least one clay selected from the group consisting of a montmorillonite, beidellite, nontronite, hectorite, saponite, sauconite, and bentonite.

In some embodiments, the water-based drilling mud has a zeta potential of at least −35 mV.

In some embodiments, the water-based drilling mud further comprises 5 to 7 w/v % of bentonite.

In some embodiments, the water-based drilling mud has a viscosity of 1 to 20 centipoise (cP).

In some embodiments, the water-based drilling mud has a stability index of at least 0.50 after 80,000 sec.

In some embodiments, the water-based drilling mud has a density of 6 to 10 pounds per gallon (ppg).

In some embodiments, the water-based drilling mud is an aqueous solution comprising at least 0.5 w/v % of the carboxybetaine zwitterionic surfactant relative to a total volume of the water-based drilling mud.

In some embodiments, the water-based drilling mud has a shear stress of 10 to 15 pounds force per 100 square feet (lbf/100 ft²) at a shear rate of 200 sec⁻¹.

In some embodiments, the water-based drilling mud has a 10 second gel strength of from 1 to 10 lbf/100 ft².

In some embodiments, the water-based drilling mud has a viscosity of 6 to 8 cP.

In some embodiments, the water-based drilling mud has a density of 8 to 9 ppg.

In some embodiments, the water-based drilling mud has a shear stress of 20 to 25 lbf/100 ft² at a shear rate of 600 sec⁻¹.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a graph illustrating zeta potential measurements of water-based mud (WBM) and carboxybetaine zwitterionic surfactant enhanced water-based mud (CBS-WBM), according to certain embodiments.

FIG. 2 is a graph illustrating the dispersion stability of WBM and CBS-WBM, according to certain embodiments.

FIG. 3 is a graph of shear stress as a function of shear rate profile for WBM and CBS-WBM, according to certain embodiments.

FIG. 4 illustrates the effect of CBS on the shale swelling behavior of WBM, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The present disclosure is intended to include all hydration states of a given compound or formula, unless otherwise noted or when heating a material. In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopically labeled compounds of the disclosure may generally be prepared by conventional techniques known to those skilled in the art or by processes analogous to those described herein, using an appropriate isotopically labelled reagent in place of the non-labelled reagent otherwise employed.

As used herein, the term ‘surfactant’ refers to a compound that lowers the surface tension (or interfacial tension) between two liquids, between a liquid and a gas, or between a liquid and a solid. In drilling muds, surfactants may aid in inhibiting shale swelling by altering the surface properties of clay particles within the shale formation, reducing their interaction with water and preventing excessive expansion when exposed to drilling fluids.

As used herein, the term, “zeta potential” is the electrostatic potential at the shear plane of a particle in a liquid, which separates the stationary layer of solvent molecules from the mobile layer of particles. The zeta potential of a particle is a measure of the electrostatic forces between the particle and its surrounding solution. A high zeta potential indicates the particles in a suspension have a strong charge and are more stable because the particles repel each other, preventing them from clumping together. A low zeta potential indicates that particles within a suspension have a weak electrostatic repulsion, making them more likely to clump together and flocculate, leading to an unstable dispersion.

As used herein, the term, “viscosity” is a measure of a fluid's resistance to flow or deformation. It describes the internal friction within a fluid that arises from the interactions between its molecules. Higher viscosity indicates a thicker fluid that flows more slowly while lower viscosity indicates a thinner fluid that flows more easily. Viscosity is typically measured in units of pascal-seconds (Pa s) or centipoise (cP). Viscosity affects how effectively a drilling mud can lift and transport drill cuttings out of a wellbore. A higher viscosity drilling mud allows the drilling mud to carry heavier particles (e.g., cuttings) to the surface, ensuring the drilling mud can support the walls of a wellbore and prevent collapse.

As used herein, the term, “density” is the mass of a substance per unit volume. It is a physical property that indicates how compact the matter within a substance is. Density is commonly measured in units of kilograms per cubic meter (kg/m³) or grams per milliliter (g/mL). The density of a drilling mud controls the ability of the drilling mud to control formation pressure during drilling by exerting a hydrostatic pressure against the wellbore walls, thus preventing influxes of formation fluids when the drilling mud density is greater than the formation pressure.

As used herein, the term, “stability index” is a measure of the stability of a system, particularly in colloidal or suspension systems, reflecting its resistance to changes such as aggregation, sedimentation, or phase separation. Specifically, the stability index of a drilling mud is used to assess how well a drilling mud can resist separation of its components (e.g., solids settling out) and maintain its overall consistency under pressure and temperature variations. A high stability index indicates the drilling mud is resistant to separation of its components, meaning the solid particles within the fluid are well suspended and unlikely to settle out, even under pressure and temperature changes, thus maintaining a stable drilling mud throughout the drilling process.

As used herein, the term “shear stress” is the force per unit area exerted parallel to the surface of a material, typically due to forces that cause one layer of the material to slide over an adjacent layer. It is a measure of the internal friction within a material when it deforms under applied force. Shear stress is commonly expressed in units of pascals (Pa) or newtons per square meter (N/m²). In relation to drilling muds, the shear stress measures the resistance to flow within the drilling mud as different layers of fluid slide pas each other at varying speeds. The shear stress may help indicate a drilling mud's ability to carry cuttings and maintain stability in a wellbore during drilling operations. A high shear stress may cause increased pump pressure, poor circulation of the drilling mud, and potential damage to the drilling equipment due to increased friction.

As used herein, the term, “gel strength” refers to the ability of a gel-like substance, such as drilling mud or other colloidal systems, to resist deformation or flow under stress. It is a measure of the rigidity or firmness of the gel structure, typically assessed by the force required to break or deform the gel. Gel strength in drilling indicates the stability of the drilling mud and its ability to suspend solid particles when circulation is stopped. It is usually measured in units of pounds per 100 square feet (lb/100 ft²) or pascals (Pa). A high gel strength in a drilling mud indicates the fluid has a strong resistance to flow and can suspend solids well, improving wellbore stability.

As used herein, a ‘10 second gel strength’ refers to the measurement of a drilling mud's shear stress at a low shear rate after it has been allowed to sit undisturbed for exactly 10 seconds, indicating its ability to hold solid particles suspended when static for a brief period.

As used herein, a ‘subterranean geological formation’ refers to a natural or human-made underground rock structure that contains oil and natural gas.

As used herein, a ‘wellbore’ refers to a hole drilled into a subterranean geological formation to extract natural resources like oil, gas, or water. It may also be referred to as a borehole or a hole.

As used herein, a ‘shale formation’ refers to a geological layer or rock formation primarily composed of shale, a fine-grained sedimentary rock made up of clay minerals, silt, and other microscopic particles. Shale formations are typically deposited in low-energy environments such as deep ocean floors, lake beds, or river deltas, where fine particles accumulate over time. Shale formations present in a wellbore may cause instability when drilling because the clay in the shale can expand when it comes into contact with drilling fluids or muds.

As used herein, ‘shale swelling’ refers to the expansion or increase in volume of shale formations when they come into contact with water-based fluids, such as drilling muds. This occurs because the clay minerals in the shale absorb water, causing them to hydrate and swell. Shale swelling can lead to wellbore instability, formation damage, and operational issues during drilling, as the expanded shale can block the wellbore, damage equipment, or cause difficulties in drilling and fluid circulation.

Aspects of the present disclosure are directed to a carboxybetaine zwitterionic surfactant formulated as an additive for inhibiting shale swelling in water-based mud (WBM) during hydrocarbon drilling. Accordingly, a method of reducing shale swelling in a wellbore having a shale formation is described.

In one embodiment, the method comprises contacting a wall of the wellbore with a water-based drilling mud to reduce absorption of water from the water-based drilling mud into the shale formation. In an embodiment, the wellbore may be present in a well selected from the group consisting of an oil well, a gas well, and a production well. An oil well is a well or shaft drilled through rock from which petroleum is drawn, while a gas well is a borehole drilled into the earth to extract natural gas from an underground reservoir. A production well is an oil well that is actively extracting oil from a reservoir, meaning it is a functional oil well currently producing oil as opposed to an exploration well which is used to identify potential oil reserves. In a preferred embodiment, the wellbore is in a production well. Production wells may be formed by known techniques in the art such as rotary drilling, directional drilling, and horizontal drilling. There are several types of production wells including, but not limited to, multilateral wells, horizontal wells, and vertical wells. A horizontal well is a well that is drilled at an angle of at least 80 degrees to the vertical. This technique is used to access oil and gas reservoirs that are difficult to reach vertically or have an abnormal shape. A vertical well is a borehole drilled straight down into the ground to access oil or natural gas reserves. A multilateral well is a well with multiple branches, or laterals, that are drilled from a single main wellbore. In some embodiments, the wellbore is present in a production well selected from the group consisting of a horizontal well, a vertical well, and a multilateral well.

Drilling muds are viscous fluids used in oil and gas drilling to lubricate the drill bit, remove cuttings, and control wellbore pressure. There are multiple types of drilling muds including water-based drilling muds, oil-based drilling muds, and synthetic-based drilling muds. A water-based drilling mud (WBM) is a drilling fluid that uses water as its main component while an oil-based drilling mud (OBM) is a drilling fluid made of oil, water, emulsifiers, wetting agents, and gellants. A synthetic-based drilling mud (SBM) is an invert emulsion mud with synthetic oil as the external phase instead of oil. In a preferred embodiment, the drilling mud is a water-based drilling mud.

In an embodiment, the drilling mud is an aqueous solution comprising at least 0.1 w/v % of a carboxybetaine zwitterionic surfactant of Formula I,

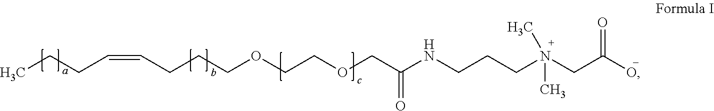

where a, b, and c are individually an integer of 1 to 20. In another embodiment, a, b, and c are individually an integer of 1 to 19, preferably 1 to 18, preferably 1 to 17, preferably 1 to 16, preferably 1 to 15, preferably 1 to 14, preferably 1 to 13, preferably 1 to 12, preferably 1 to 11, most preferably 1 to 10. In another embodiment, a, b, and c are individually an integer between 1 to 20, such as 1, 2, 3, 4, 5, 6, 7, 8, 9, 10, 11, 12, 13, 14, 15, 16, 17, 18, 19, and 20. In an embodiment, the drilling mud is an aqueous solution comprising at least 0.11 w/v % of the carboxybetaine zwitterionic surfactant of Formula I, preferably at least 0.12 w/v %, preferably at least 0.13 w/v %, preferably at least 0.14 w/v %, preferably at least 0.15 w/v %, preferably at least 0.16 w/v %, preferably at least 0.17 w/v %, preferably at least 0.18 w/v %, preferably at least 0.19 w/v %, preferably at least 0.20 w/v %, preferably at least 0.21 w/v %, preferably at least 0.22 w/v %, preferably at least 0.23 w/v %, preferably at least 0.24 w/v %, preferably at least 0.25 w/v %, preferably at least 0.26 w/v %, preferably at least 0.27 w/v %, preferably at least 0.28 w/v %, preferably at least 0.29 w/v %, preferably at least 0.30 w/v %, preferably at least 0.31 w/v %, preferably at least 0.32 w/v %, preferably at least 0.33 w/v %, preferably at least 0.34 w/v %, preferably at least 0.35 w/v %, preferably at least 0.36 w/v %, preferably at least 0.37 w/v %, preferably at least 0.38 w/v %, preferably at least 0.39 w/v %, preferably at least 0.40 w/v %, preferably at least 0.41 w/v %, preferably at least 0.42 w/v %, preferably at least 0.43 w/v %, preferably at least 0.44 w/v %, preferably at least 0.45 w/v %, preferably at least 0.46 w/v %, preferably at least 0.47 w/v %, preferably at least 0.48 w/v %, preferably at least 0.49 w/v %, preferably at least 0.50 w/v % of the carboxybetaine zwitterionic surfactant of Formula I. In a preferred embodiment, the drilling mud is an aqueous solution comprising at least 0.5 w/v % of the carboxybetaine zwitterionic surfactant of Formula I.

In some embodiments, the drilling mud is an aqueous solution comprising water. Suitable examples of water include, but are not limited to, tap water, distilled water, bi-distilled water, deionized water, deionized distilled water, reverse osmosis water, hard water, fresh water, and brine water. In another embodiment, the brine water, the hard water, and the freshwater comprise salts of sodium, magnesium, calcium, potassium, ammonium, and iron, and anions such as chloride, bicarbonate, carbonate, sulfate, sulfite, phosphate, iodide, nitrate, acetate, citrate, fluoride, and nitrite.

In an embodiment, the water-based drilling mud further comprises at least one inorganic base selected from the group consisting of potassium hydroxide, calcium hydroxide, magnesium hydroxide, barium hydroxide, and sodium hydroxide. Inorganic bases may be added to water-based drilling muds to regulate the pH level of the drilling mud, ensuring stability of the wellbore, prevention of equipment corrosion, and optimization of drilling efficiency. A drilling mud with a high pH can cause excessive swelling of clay particles in the mud, leading to high viscosity and difficult in circulating the drilling mud. A drilling mud with a low pH, however, can decrease the viscosity of the drilling mud, making it less effective to carrying cuttings and stabilizing the wellbore. Further, drilling muds with low pHs can be corrosive to drilling equipment. In a preferred embodiment, the water-based drilling mud further comprises sodium hydroxide. In an embodiment, the water-based drilling mud further comprises 0.01 to 0.10 w/v % sodium hydroxide. In some embodiments, the drilling mud further comprises 0.015 to 0.095 w/v % sodium hydroxide, preferably 0.02 to 0.09 w/v %, preferably 0.025 to 0.085 w/v %, preferably 0.03 to 0.08 w/v %, preferably 0.035 to 0.075 w/v %, preferably 0.04 to 0.07 w/v %, preferably 0.04 to 0.065 w/v %, preferably 0.04 to 0.06 w/v %, preferably 0.04 to 0.055 w/v %, preferably 0.04 to 0.05 w/v %, most preferably 0.04 to 0.045 w/v % sodium hydroxide. In a preferred embodiment, the water-based drilling mud comprises 0.0428 w/v % sodium hydroxide. In one embodiment, the water-based drilling mud has a pH of 6 to 14, preferably 6.5 to 13.5, preferably 7 to 13, preferably 7.5 to 12.5, preferably 8 to 12, preferably 8.5 to 11.5, most preferably 9 to 10.

In one embodiment, the water-based drilling mud further comprises at least one clay selected from the group consisting of a montmorillonite, a beidellite, a nontronite, a hectorite, a saponite, a sauconite, and a bentonite. In water-based drilling muds, clays may be added to help control the viscosity of the drilling mud. Clay particles have a high cation exchange capacity, allowing them to absorb water and expand to obtain a gel-like structure that increases the viscosity of the drilling mud. The amount of clay added to the drilling mud influences the viscosity of the drilling mud, with higher concentrations resulting in drilling muds with increased viscosity. Increased clay concentrations in drilling muds may, however, result in a thick filter cake which hinders fluid flow and reduces drilling efficiency. Furthermore, properties of the clay particles, such as particle size, may impact the viscosity of the drilling mud with smaller clay particles providing better viscosity control due to their larger surface area for water interaction. In a preferred embodiment, the water-based drilling mud further comprises bentonite. Bentonite clay may absorb increased amounts of water, compared to other clays, causing the bentonite particles to swell and form a thick, viscous gel that seals the walls of a wellbore and prevents collapse of the formation around the drill. Bentonite may also act as a protective filter cake against fluid loss, helping to maintain the integrity of the wellbore during drilling operations, and a lubricant, reducing friction between the drilling equipment and the walls of the wellbore. Suitable examples of bentonite may include, but are not limited to, potassium bentonite, sodium bentonite, calcium bentonite, aluminum bentonite, and combinations thereof. In some embodiments, the water-based drilling mud further comprises 1 to 10 w/v % of bentonite relative to a total volume of the water-based drilling mud. In another embodiment, the water-based drilling mud further comprises 1.2 to 9.8 w/v % of bentonite, preferably 1.4 to 9.6 w/v %, preferably 1.6 to 9.4 w/v %, preferably 1.8 to 9.2 w/v %, preferably 2 to 9 w/v %, preferably 2.2 to 8.8 w/v %, preferably 2.4 to 8.6 w/v %, preferably 2.6 to 8.4 w/v %, preferably 2.8 to 8.2 w/v %, preferably 3 to 8 w/v %, preferably 3.2 to 7.8 w/v %, preferably 3.4 to 7.6 w/v %, preferably 3.6 to 7.4 w/v %, preferably 3.8 to 7.2 w/v %, preferably 4 to 7 w/v %, preferably 4.2 to 7 w/v %, preferably 4.4 to 7 w/v %, preferably 4.6 to 7 w/v %, preferably 4.8 to 7 w/v %, preferably 5 to 7 w/v %, preferably 5.2 to 7 w/v %, preferably 5.4 to 7 w/v %, preferably 5.6 to 7 w/v %, preferably 5.8 to 7 w/v %, preferably 6 to 7 w/v %, preferably 6.2 to 7 w/v %, most preferably 6.8 to 7 w/v % of bentonite. In a preferred embodiment, the water-based drilling mud further comprises 6.857 w/v % of bentonite.

In an embodiment, the water-based drilling mud may further comprise at least one additive selected from the group consisting of weighting agents, emulsifiers, viscosifiers, fluid-loss control agents, corrosion inhibitors, defoamers, clay stabilizers, anti-scalants, deflocculants, lubricants, wellbore strengthening materials, gelling agents, high temperature/high pressure control additives, surface modifying agents, tackifying agents, wetting agents, coating enhancement agents, and filter cake removal agents. A weighting agent may be added to a drilling mud to increase the density of the drilling mud, allowing it to counteract the pressure of the formation being drilled to prevent blowouts of the wellbore. Suitable weight agents may include, but are not limited to, hematite, ilmenite, barite, calcium carbonate, and manganese tetroxide. Emulsifiers aid in stabilizing the emulsion of small water droplets within the drilling mud, preventing them from coalescing into larger droplets and separating out, thereby maintaining the drilling muds stability during drilling operations. Emulsifiers may also aid in controlling fluid loss by preventing the drilling mud from leaking excessively into the rock pores of the formation. Examples of emulsifiers for water-based drilling muds may include sulfonated hydrocarbons, ethoxylated nonylphenols, and alkali-metal fatty-acid soaps. Viscosifiers added to water-based drilling muds may increase the drilling mud's viscosity, allowing the drilling mud to suspend and carry rock cuttings up the wellbore by creating a thicker, more resistant flow that can withstand the forces of circulation. This improves the drilling mud's ability to clean the wellbore by preventing cuttings from settling to the bottom of the well. Suitable viscosifiers may include, but are not limited to, hydroxyethylcellulose (HEC), attapulgite, polymeric compounds, lignite, and polymer fluids. Fluid-loss control agents in water-based drilling muds work by creating a thin, impermeable filter cake on the wellbore wall, which prevents excessive liquid from leaking out of the drilling mud into the surrounding formation while still allowing cuttings to be carried to the surface. Examples of fluid-loss control agents used in water-based drilling muds include starches (e.g., corn, potato, cassava), polyanionic cellulose (PAC), lignosulfonates, carboxymethyl cellulose (CMC), modified cellulosic materials, bentonite, and certain natural polymers like guar gum or gum arabic. Corrosion inhibitors in water-based drilling muds may reduce the rate of corrosion on the metal surfaces of drilling equipment by forming a protective film on the metal, acting as a barrier between the metal and the corrosive elements within the drilling mud. Suitable corrosion inhibitors include, but are not limited to, phosphates (e.g., orthophosphates), nitrates, molybdates, various organic compounds like fatty acids, sulfonates, and cationic surfactants like cetyl trimethyl ammonium bromide (CTAB). Defoamers work by reducing the surface tension of the drilling mud, which prevents the formation of excessive foam, thereby improving the drilling mud's ability to effectively remove drill cuttings, maintain proper pressure control, and prevent operational issues like pump cavitation. Suitable defoamers include silicone-based compounds, long-chain fatty alcohols, fatty acid soaps, mineral oils, aluminum stearate, and certain types of vegetable oils. Clay stabilizers added to drilling muds aid in preventing clay particles from swelling excessively by modifying their surface chemistry, thus minimizing formation damage, maintaining wellbore stability, and ensuring smooth drilling operations by inhibiting the absorption of water by the clay formations encountered during drilling. Common clay stabilizers include potassium chloride, cationic polymers (e.g., quaternary ammonium compounds), modified polymers, inorganic salts, and amine-based additives. Anti-scalants added to drilling muds prevent the formation of mineral deposits (scale) by disrupting the crystallization process, essentially stopping the growth of scale crystals that could block the wellbore and hinder fluid flow. Suitable anti-scalants include but are not limited to polyphosphinocarboxylic acid (PPCA), diethylenetriaminepenta(methylene phosphonic acid) (DTPMP), organophosphonates, and polymeric phosphonates. Deflocculants may help disperse solid particles within the drilling mud by neutralizing the particles' surface charges, effectively reducing the viscosity and gel strength of the drilling mud, allowing it to flow more freely through the wellbore while drilling. Common deflocculants are lignosulfonates, polyphosphates, quebracho extract, and tannins. Lubricants in the drilling mud may aid in reducing friction between the drill string and the rock formations, lowering drag and torque, thereby improving drilling efficiency. Common lubricants include graphite, lignosulfonates, polyethylene glycols (PEGs), synthetic polymers like polyacrylamide, and various fatty acids (e.g., stearic acid). Wellbore strengthening materials may be added to drilling muds to increase the drilling mud's ability to plug microfractures in the wellbore, thereby enhancing the formation's stability and preventing fluid loss by sealing cracks and improving the overall strength of the wellbore wall. Suitable examples of wellbore strengthening materials include, but are not limited to, asphaltite and graphite. Gelling agents may increase the drilling mud's viscosity and yield strength, allowing the drilling mud to effectively suspend and transport drilled cuttings, preventing them from settling to the bottom of the wellbore. Suitable gelling agents include, but are not limited to, xanthan gum, guar gum, CMC, PAC, starch, and HEC. High temperature/high pressure control additives such as polyacrylamide derivatives, modified cellulose polymers, sulfonated polymers, and silicates, may be added to drilling muds to enhance the stability of the drilling mud and mitigating the degradation effects of high temperature and pressure on the drilling mud. Surface modifying agents may alter the surface properties of the fluid particles within the drilling mud, improving drilling efficiency by reducing the prevalence of complications like stuck pipes or formation damage. Examples of surface modifying agents include xanthan gum, guar gum, starch, cellulose, modified starches, PAC, cationic polymers, lignosulfonates, chitosan, and acrylamide copolymers. Tackifying agents may increase the viscosity and adhesion of the drilling mud, making it stick more to the wellbore walls, which helps to prevent fluid loss, stabilizes the wellbore, and lifts cuttings more effectively during drilling operations. Common tackifying agents are xanthan gum, CMC, guar gum, HEC, starch, polyacrylamide (PAM), lignosulfonates, and quebracho tannins. Filter cake removal agents may be added to drilling muds to aid in dissolving solid particles deposited on the formation wall (filter cake), cleaning the wellbore and restoring permeability by breaking down the filter cake's structure and allowing for better fluid flow during drilling operations. Examples of filter cake removal agents include, but are not limited to, acids (e.g., hydrochloric acid, ferrous chloride, organic acid precursors), oxidizers (e.g., ammonium persulfate, sodium persulfate, magnesium peroxide), briding agents (e.g., magnesium oxide, manganese oxide, calcium oxide), and chelating agents (e.g., diethylene triamine penta acetic acid (DTPA)). In a preferred embodiment, in the water-based drilling mud, the carboxybetaine zwitterionic surfactant is the only organic compound dissolved in the water, preferably the only oxygen-containing organic compounds and/or the only organic compound having bothhydroxyl and amide group.

In some embodiments, the water-based drilling mud has a viscosity of 1 to 30 cP. In another embodiment, the water-based drilling mud has a viscosity of 2 to 29 cP, preferably 3 to 28 cP, preferably 4 to 27 cP, preferably 5 to 26 cP, preferably 6 to 25 cP, preferably 6 to 24 cP, preferably 6 to 23 cP, preferably 6 to 22 cP, preferably 6 to 21 cP, preferably 6 to 20 cP, preferably 6 to 19 cP, preferably 6 to 18 cP, preferably 6 to 17 cP, preferably 6 to 16 cP, preferably 6 to 15 cP, preferably 6 to 14 cP, preferably 6 to 13 cP, preferably 6 to 12 cP, preferably 6 to 11 cP, preferably 6 to 10 cP, preferably 6 to 9 cP, most preferably 6 to 8 cP.

In an embodiment, the water-based drilling mud has a density of 1 to 20 pounds per gallon (ppg). In another embodiment, the water-based drilling mud has a density of 2 to 19 ppg, preferably 3 to 18 ppg, preferably 4 to 17 ppg, preferably 5 to 16 ppg, preferably 6 to 15 ppg, preferably 7 to 14 ppg, preferably 8 to 13 ppg, preferably 8 to 12 ppg, preferably 8 to 11 ppg, preferably 8 to 10 ppg, most preferably 8 to 9 ppg.

In one embodiment, the water-based drilling mud has a zeta potential of at least −30 mV. In another embodiment, the water-based drilling mud has a zeta potential of at least −30.5 mV, preferably at least −31 mV, preferably at least −31.5 mV, preferably at least −32 mV, preferably at least −32.5 mV, preferably at least −33 mV, preferably at least −33.5 mV, preferably at least −34 mV, preferably at least −34.5 mV, preferably at least −35 mV, preferably at least −35.5 mV, preferably at least −36 mV, preferably at least −36.5 mV, preferably at least −37 mV, most preferably −37.44 mV.

In some embodiments, the water-based drilling mud has a 10 second gel strength of 1 to 20 lbf/100 ft². In another embodiment, the water-based drilling mud has a 10 second gel strength of 1.5 to 19.5 lbf/100 ft², preferably 2 to 19 lbf/100 ft², preferably 2 to 18.5 lbf/100 ft², preferably 2 to 18 lbf/100 ft², preferably 2 to 17.5 lbf/100 ft², preferably 2 to 17 lbf/100 ft², preferably 2 to 16.5 lbf/100 ft², preferably 2 to 16 lbf/100 ft², preferably 2 to 15.5 lbf/100 ft², preferably 2 to 15 lbf/100 ft², preferably 2 to 14.5 lbf/100 ft², preferably 2 to 14 lbf/100 ft², preferably 2 to 13.5 lbf/100 ft², preferably 2 to 13 lbf/100 ft², preferably 2 to 12.5 lbf/100 ft², preferably 2 to 12 lbf/100 ft², preferably 2 to 11.5 lbf/100 ft², preferably 2 to 11 lbf/100 ft², preferably 2 to 10.5 lbf/100 ft², preferably 2 to 10 lbf/100 ft², preferably 2 to 9.5 lbf/100 ft², preferably 2 to 9 lbf/100 ft², preferably 2 to 8.5 lbf/100 ft², preferably 2 to 8 lbf/100 ft², preferably 2 to 7.5 lbf/100 ft², preferably 2 to 7 lbf/100 ft², preferably 2 to 6.5 lbf/100 ft², preferably 2 to 6 lbf/100 ft², preferably 2 to 5.5 lbf/100 ft², most preferably 2 to 5 lbf/100 ft².

In an embodiment, the water-based drilling mud has a stability index of at least 0.05 after 10,000 sec. In another embodiment, the water-based drilling mud has a stability index of at least 0.055, preferably at least 0.06, preferably at least 0.065, preferably at least 0.07, preferably at least 0.075, preferably at least 0.08, preferably at least 0.085, preferably at least 0.09, preferably at least 0.095, most preferably at least 0.01 after 10,000 sec. In one embodiment, the water-based drilling mud has a stability index of at least 0.1 after 30,000 sec. In another embodiment, the water-based drilling mud has a stability index of at least 0.105, preferably at least 0.11, preferably at least 0.115, preferably at least 0.12, preferably at least 0.125, preferably at least 0.13, preferably at least 0.135, preferably at least 0.14, preferably at least 0.145, preferably at least 0.15, preferably at least 0.155, preferably at least 0.16, preferably at least 0.165, preferably at least 0.17, preferably at least 0.175, preferably at least 0.18, preferably at least 0.185, preferably at least 0.19, preferably at least 0.195, preferably at least 0.2, preferably at least 0.205, preferably at least 0.21, preferably at least 0.215, preferably at least 0.22, preferably at least 0.225, preferably at least 0.23, preferably at least 0.235, preferably at least 0.24, preferably at least 0.245, preferably 0.25, preferably at least 0.255, preferably at least 0.26, preferably at least 0.265, preferably at least 0.27, most preferably at least 0.275 after 30,000 sec. In an embodiment, the water-based drilling mud has a stability index of at least 0.15 after 50,000 sec. In another embodiment, the water-based drilling mud has a stability index of at least 0.2, preferably at least 0.22, preferably at least 0.24, preferably at least 0.26, preferably at least 0.28, preferably at least 0.3, preferably at least 0.32, preferably at least 0.34, preferably at least 0.36, most preferably at least 0.38 after 50,000 sec. In one embodiment, the water-based drilling mud has a stability index of at least 0.2 after 80,000 sec. In another embodiment, the water-based drilling mud has a stability index of at least 0.22, preferably at least 0.24, preferably at least 0.26, preferably at least 0.28, preferably at least 0.3, preferably at least 0.32, preferably at least 0.34, preferably at least 0.36, preferably at least 0.38, preferably at least 0.4, preferably at least 0.42, preferably at least 0.44, preferably at least 0.46, preferably at least 0.48, most preferably at least 0.5 after 80,000 sec.

In an embodiment, the water-based drilling mud has a shear stress of 8 to 10 lbf/100 ft² at a shear rate of 0 sec⁻¹. In another embodiment, the water-based drilling mud has a shear stress of 8.1 to 9.9 lbf/100 ft², preferably 8.2 to 9.8 lbf/100 ft², preferably 8.3 to 9.7 lbf/100 ft², preferably 8.4 to 9.6 lbf/100 ft², preferably 8.5 to 9.5 lbf/100 ft², preferably 8.6 to 9.4 lbf/100 ft², preferably 8.7 to 9.3 lbf/100 ft², preferably 8.8 to 9.2 lbf/100 ft², preferably 8.9 to 9.1 lbf/100 ft², most preferably 9 lbf/100 ft² at a shear rate of 0 sec⁻¹. In an embodiment, the water-based drilling mud has a shear stress of at least 10 lbf/100 ft² at a shear rate of 200 sec⁻¹. In another embodiment, the water-based drilling mud has a shear stress of at least 10.1 lbf/100 ft², preferably at least 10.2 lbf/100 ft², preferably at least 10.3 lbf/100 ft², preferably at least 10.4 lbf/100 ft², preferably at least 10.5 lbf/100 ft², preferably at least 11 lbf/100 ft², preferably at least 11.5 lbf/100 ft², preferably at least 12 lbf/100 ft², preferably at least 12.5 lbf/100 ft², preferably at least 13 lbf/100 ft², preferably at least 13.5 lbf/100 ft², preferably at least 14 lbf/100 ft², preferably at least 14.5 lbf/100 ft², most preferably 15 lbf/100 ft² at a shear rate of 200 sec⁻¹. In an embodiment, the water-based drilling mud has a shear stress of at least 20 lbf/100 ft² at a shear rate of 800 sec⁻¹. In another embodiment, the water-based drilling mud has a shear stress of at least 20.5 lbf/100 ft², preferably at least 21 lbf/100 ft², preferably at least 21.5 lbf/100 ft², preferably at least 22 lbf/100 ft², preferably at least 22.5 lbf/100 ft², preferably at least 23 lbf/100 ft², preferably at least 23.5 lbf/100 ft², preferably at least 24 lbf/100 ft², preferably at least 24.5 lbf/100 ft², preferably at least 25 lbf/100 ft², preferably at least 25.5 lbf/100 ft², preferably at least 26 lbf/100 ft², preferably at least 26.5 lbf/100 ft², preferably at least 27 lbf/100 ft², preferably at least 27.5 lbf/100 ft², preferably at least 28 lbf/100 ft², preferably at least 28.5 lbf/100 ft², preferably at least 29 lbf/100 ft², preferably at least 29.5 lbf/100 ft², most preferably at least 30 lbf/100 ft² at a shear rate of 800 sec⁻¹.

In some embodiments, upon contacting the wall of the wellbore with the water-based drilling mud comprising the carboxybetaine zwitterionic surfactant of Formula I, the shale swelling is reduced by at least 10% compared to a water-based drilling mud that is the same as the water-based drilling mud but does not contain the carboxybetaine zwitterionic surfactant. In another embodiment, upon contacting the wall of the wellbore with the water-based drilling mud comprising the carboxybetaine zwitterionic surfactant of Formula I, the shale swelling is reduced by at least 12%, preferably at least 14%, preferably at least 16%, preferably at least 18%, preferably at least 20%, preferably at least 22%, preferably at least 24%, preferably at least 26%, preferably at least 28%, preferably at least 30%, preferably at least 32%, preferably at least 34%, preferably at least 36%, preferably at least 38%, preferably at least 40%, most preferably at least 42% compared to a water-based mud that is the same as the water-based drilling mud but does not contain the carboxybetaine zwitterionic surfactant.

### EXAMPLES

The following examples demonstrate a method of reducing shale swelling in a wellbore having a shale formation. The examples are provided solely for illustration and are not to be construed as limitations of the present disclosure, as many variations thereof are possible without departing from the spirit and scope of the present disclosure.

### Example 1: Preparation of the Drilling Mud

The drilling mud was prepared by mixing 6 w/v % bentonite and deionized (DI) water, using a Hamilton Beach mixer, following the American petroleum institute (API) standard. The pH of the solution was adjusted using sodium hydroxide (NaOH). Further, to prepare the surfactant-water based drilling mud (WBM), 0.5 w/v % of carboxybetaine zwitterionic surfactant (CBS) was added to the drilling mud. The additives used herein, and subsequent concentration of the additives are listed in Table 1. The formulated drilling mud was preserved at an ambient condition for 24 hours before testing.

TABLE 1
Composition of drilling fluid

| Additive | Base mud | | CBS drilling fluid | |
|---|---|---|---|---|
| Water (H₂O) | 350 | ml | 350 | ml |
| Bentonite | 24 | g | 24 | g |
| Sodium hydroxide (NaOH) | 0.15 | g | 0.15 | g |

| | | | |
|---|---|---|---|
| Surfactant | — | 0.5 | w/v % |

### Example 2: Zeta Potential Measurement and Dispersion Analysis

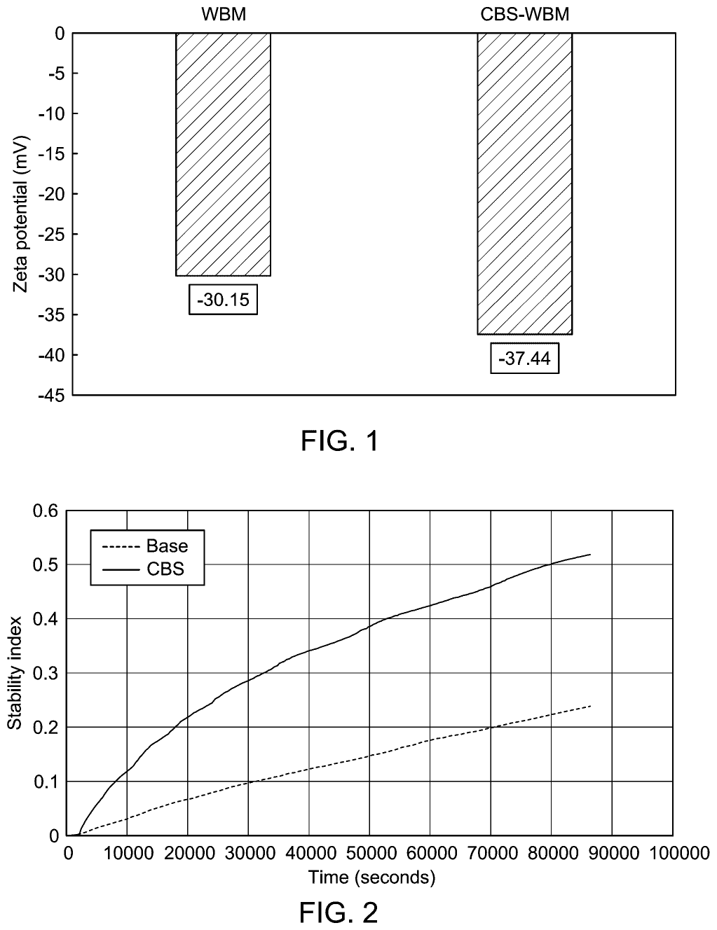

The zeta potential of the formulated base drilling mud and carboxybetaine zwitterionic surfactant water-based drilling mud (CBS-WBM) was measured using the Anton Paar Litesizer 500 to estimate the electrokinetic potential of the WBM. The dispersion analysis of the WBM and CBS-WBM was conducted using Dataphysics MultiScan MS 20. The electrokinetic stability behavior of WBM and surfactant stabilized WBM (CBS-WBM) are shown in FIG. 1. The WBM has a zeta potential of −30.15 millivolts (mV) while CBS-WBM has a zeta potential of −36.89 mV. Further, the colloidal stability of WBM improves with the addition of the carboxybetaine zwitterionic surfactant. As shown in FIG. 2, the dispersion stability of WBM and CBS-WBM was analyzed over a 24 h period. CBS-WBM recorded a stability index of 0.52, while WBM had a stability index of 0.24.

### Example 3: Rheological Measurement

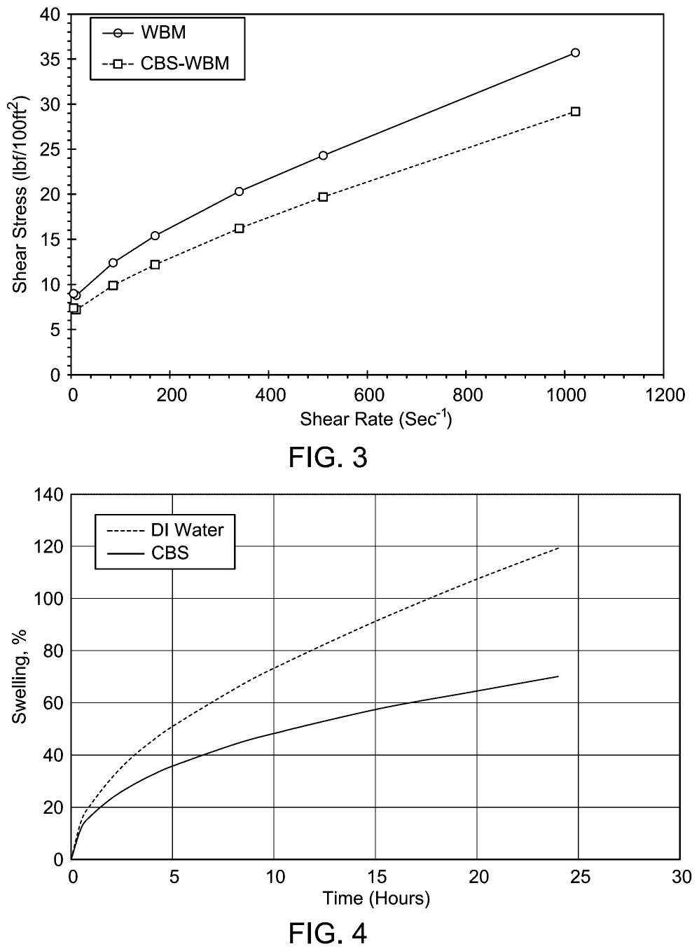

In order to determine the deformation behavior of the drilling fluids, rheological tests were conducted using a TA rheometer. In particular, the shear stress versus the shear rate for both WBM and CBS-WBM were measured. As can be seen in FIG. 3, the shear stress of the conventional WBM and CBS-WBM are plotted as a function of shear rate. The shear stress improves in proportion with shear rate, thus exhibiting non-Newtonian behavior. The surfactant additive results in a decrease in shear stress compared to the conventional WBM. The decreased shear stress may be due to the disruption of attractive forces between the carboxybetaine zwitterionic surfactant and bentonite particles of the CBS-WBM, allowing for the dispersion of the bentonite particles in the drilling mud and prevention of the bentonite particles from forming a cohesive network that contributes to high viscosity and shear stress.

### Example 4: Shale Inhibition Test

In order to estimate the efficiency of the carboxybetaine zwitterionic surfactant as a clay hydration inhibition additive, a linear shale swelling test was conducted. The procedure included inserting clay wafer into DI water and carboxybetaine surfactant (CBS) solution. Subsequently, the clay hydration behavior was measured using oil field instrumentation and testing equipment (OFITE) dynamic swell meter, which includes an integrated software for analysis. Furthermore, the shale swelling behavior of the formulated drilling fluids was evaluated via linear shale swelling tests, as shown in FIG. 4. WBM displayed an expansion of about 120% over a 24-hr period. The expansion may be because the water molecules of the WBM permeate through the interstices of the shale particles, hence hydrating the shale leading to shale swelling. In contrast, the CBS-WBM displayed an inhibition of swelling by 42%. The reduced swelling behavior demonstrated by CBS-WBM may be attributed to the insertion of surfactant into the layered structure of the clay, thereby limiting the penetration of water into its crystalline structure.

Numerous modifications and variations of the present disclosure are possible in light of the above teachings. It is, therefore, to be understood that within the scope of the appended claims, the invention may be practiced otherwise than as specifically described herein.

1. A method of reducing shale swelling in a wellbore in a shale formation, comprising:
contacting a wall of the wellbore with a water-based drilling mud to reduce absorption of water from the water-based drilling mud into the shale formation;
wherein the drilling mud is an aqueous solution comprising at least 0.1 w/v % of a carboxybetaine zwitterionic surfactant of Formula I, 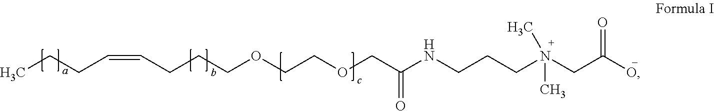
wherein a, b, and c are individually an integer from 1 to 20, and
wherein the shale swelling is reduced by at least 10% compared to a second drilling mud that is the same as the water-based drilling mud but does not contain the carboxybetaine zwitterionic surfactant.

2. The method of claim 1, wherein water-based drilling mud has a zeta potential of at least −31 mV.

3. The method of claim 1, wherein the shale swelling is reduced by at least 30% compared to the second drilling mud.

4. The method of claim 1, wherein the water-based drilling mud has a stability index of at least 0.40 after 50,000 sec.

5. The method of claim 1, wherein the water-based drilling mud further comprises 0.01 to 0.10 w/v % of at least one inorganic base selected from the group consisting of potassium hydroxide, calcium hydroxide, magnesium hydroxide, barium hydroxide, and sodium hydroxide.

6. The method of claim 1, wherein the water-based drilling mud is an aqueous solution comprising at least 0.25 w/v % of the carboxybetaine zwitterionic surfactant.

7. The method of claim 1, wherein the shale swelling is reduced by at least 42% compared to the second drilling mud.

8. The method of claim 1, wherein the water-based drilling mud further comprises 0.04 to 0.045 w/v % of sodium hydroxide.

9. The method of claim 1, wherein the water-based drilling mud further comprises 1 to 10 w/v % of at least one clay selected from the group consisting of a montmorillonite, a beidellite, a nontronite, a hectorite, a saponite, a sauconite, and a bentonite.

10. The method of claim 1, wherein water-based drilling mud has a zeta potential of at least −35 mV.

11. The method of claim 1, wherein the water-based drilling mud further comprises 5 to 7 w/v % of bentonite.

12. The method of claim 1, wherein the water-based drilling mud has a viscosity of 1 to 20 cP.

13. The method of claim 1, wherein the water-based drilling mud has a stability index of at least 0.50 after 80,000 sec.

14. The method of claim 1, wherein the water-based drilling mud has a density of 6 to 10 ppg.

15. The method of claim 1, wherein the water-based drilling mud is an aqueous solution comprising at least 0.5 w/v % of the carboxybetaine zwitterionic surfactant.

16. The method of claim 1, wherein the water-based drilling mud has a shear stress of 10 to 15 lbf/100 ft² at a shear rate of 200 sec⁻¹.

17. The method of claim 1, wherein the water-based drilling mud has a 10 second gel strength of from 1 to 20 lbf/100 ft².

18. The method of claim 1, wherein the water-based drilling mud has a viscosity of 6 to 8 cP.

19. The method of claim 1, wherein the water-based drilling mud has a density of 8 to 9 ppg.

20. The method of claim 1, wherein the water-based drilling mud has a shear stress of 20 to 25 lbf/100 ft² at a shear rate of 600 sec⁻¹.
